(19) United States
(12) Patent Application Publication
(10) Pub. No.: US 2013/0218669 A1
(43) Pub. Date: Aug. 22, 2013

(54) METHOD AND SYSTEM FOR QUANTIFYING INTERACTIONS WITH DIGITAL CONTENT

(71) Applicant: DIDGEBRIDGE LLC, (US)

(72) Inventors: JOHN F. MCNULTY, Carmel, IN (US); RYAN D. SWADLEY, Carmel, IN (US)

(21) Appl. No.: 13/849,902

(22) Filed: Mar. 25, 2013

Related U.S. Application Data
(62) Division of application No. 12/777,096, filed on May 10, 2010.

(51) Int. Cl. G06Q 30/02

(52) U.S. Cl. CPC G06Q 30/0246
USPC 705/14.45

(57) ABSTRACT

A computerized system and method for displaying content to a plurality of users via a communications network, and for quantifying interactions between the users and the digital content utilizes a first computer program stored in a memory of a computer accessible to a user. A program module in the computer program causes the computer to confirm access of the digital content by the user, and to quantify a plurality of interactions between the user and the digital content. Data representative of the interactions are stored and/or uploaded via the communications network to a database. A second computer program is stored in the memory of a computer accessible to an entity authorized to access the data in the database. The second computer program may include an accounting module for creating an account record which reflects a charge to the accessing entity which varies based on the data in the database.

### RELATED APPLICATIONS

The present application is a divisional application of U.S Utility application Ser. No. 12/777,096, filed on May 10, 2010, entitled “Method and System for Quantifying Interactions with Digital Content” and claims priority to U.S. Provisional Patent Application, Ser. No. 61/176,693 filed on May 8, 2009, entitled “Method and System for Quantifying Interactions with Digital Content.” The subject matter disclosed in these applications is hereby expressly incorporated into the present application in its entirety.

### TECHNICAL FIELD

The present disclosure relates generally to a computer-based method and system for making digital content available to a user, and for quantifying interactions between the user and the digital content. More specifically, the disclosed method and system detects, measures and records increasing levels of interactions to enable an entity associated with the digital content to judge the effectiveness of the content. A particular application of the method and system involves the generation of tracking and metrics data that can be viewed by the creators or sponsors of advertising content.

### BACKGROUND AND SUMMARY

Traditional advertising content takes a plurality of forms. Some examples include print advertisements, such as brochures, newspaper and magazine ads and direct mail advertisements, radio advertising, traditional 15-30 second television commercials, and in more recent times, infomercials. All of these forms of traditional advertising create the possibility of exposure to the advertisement content by one or more members of the consuming public. However, it has not been practical to confirm in most instances actual exposure of a particular individual to such content. Nor has it been practical to provide for a meaningful level of interactions, or to monitor such interactions, between the content and individuals whose exposure to the content is confirmed.

The advent of computer networks, particularly the Internet™, has created an alternative channel of trade for both consumers and vendors of products and services. Unlike television, radio, and print media, the Internet™ is capable of relatively high degrees of interactions between a computer user and digital content available to the user via his or her computer. Nevertheless, much of the advertising of goods and services on the Internet™ relies on the traditional technique of creating the possibility of exposure on the part of the computer user to particular content. In most cases, the extent of the interaction between the user and the content is the user's ability to “click” on an ad and be directed to a website featuring a vendor or product. Advertisers are typically charged a fee for each “click” or visitor to a site, whether or not the user spends a meaningful amount of time on the site or otherwise interacts with the site to indicate a high level of interest in the content.

This disclosure relates generally to a computerized system and method for confirming and quantifying interactions with digital content accessible to a user via a network. The system and method are particularly well-suited for use with advertising content, and for providing advertisers with measures of the effectiveness of digital advertising content.

In one embodiment, the system comprises a first computer program which is stored in the memory of a computer accessible to a user. The computer program may be stored in the user's personal computer or, alternatively, on a computer that is accessible to the user over a network, such as the Internet™. The first computer program is configured to allow the user to access digital content available from a source of digital content connected to the network. The program includes a module which causes the second computer to confirm access of the digital content by the user, and to quantify a plurality of interactions between the user and the digital content. Data representative of these quantifications is stored, and a sending module in the program causes the computer to transmit the data to a database. A second computer program is stored in the memory of a computer accessible to an entity associated with the content and authorized to access the data. The second computer program includes an account module for creating an account record containing identifying information specific to the entity, and a display module for creating entity-specific displays from the data. One or both of the computer programs include a charge module configured to determine and store a charge based upon the data representative of the quantifications. The amount or level of the charge determined by the charging module increases with increasing levels of interactions between the user and the digital content, as measured by and reflected in the data representative of the quantifications.

In one embodiment, the program module in the first computer program is configured to determine whether the user has accessed or viewed all, or only a part of, a designated portion of a digital content. For example, if the digital content is in the form of a video, the program module determines whether the user has viewed the video to completion. The charging module is configured to determine a charge based upon whether the user accessed all, or only a part of, the video.

The program module may be further configured to determine whether the user interacted with the digital content so as to cause additional, related content to be made available to the user. For example, the user may have requested specifications for a product featured in the digital content. In such a case, the charge module is configured to cause an additional charge to be assessed and stored in the database.

The program module may also determine whether the user forwards information relating to the digital content to another user, or to an online community of users. Again, the charge module may be configured to assess an additional charge if such interaction is detected.

The program module may be further configured to determine whether the user exhibits a heightened degree of interaction with the digital content by downloading information relating to the content for storage on the user's computer. In one embodiment, such downloaded information may include an incentive in the form of, for example, a coupon or promotional code. The coupon or promotional code may be associated with data or an indicia indicative of the source of the incentive such that, if the user redeems the incentive in an actual purchase of products/services, data reflecting that transaction can be stored and subsequently linked to the user's exposure to the digital content so as to confirm the effectiveness of the content. As with the previous levels of interaction, the active downloading of additional information, including incentive data, may cause the charge module to assess an additional (and higher) charge. The amounts of the charges are subsequently paid by the entity sponsoring or affiliated with the digital content.

In another embodiment, a system for quantifying interactions between a user and digital content accessible over a communication network comprises a storage device and a processor. The storage device is configured to store a computer program. The computer program is operable when executed by the processor to cause the processor to perform the steps of receiving a list of selected digital content files available over the communications network, streaming a selected digital content file for display to the user, confirming receipt and display of the file, quantifying a plurality of interactions between the user and the selected digital content, and transmitting data representative of the interactions to a remote database using the communications network. This system may further comprise a second storage device configured to store a second computer program, and a second processor in communication with the second storage device. The second computer program is operable, when executed by the second processor, to cause the second processor to perform the steps of creating an account for an entity associated with the digital content and displaying data stored in the database relating to the digital content in an entity-specific display. One or both of the first and second computer programs may be configured to cause the processor to perform the step of assessing a charge based upon entity-specific data stored in the database. In a preferred embodiment, a level of the charge assessed increases with increasing levels of interactions between the user and the digital content, as measured by the data in the database.

A computerized method for displaying digital content to a plurality of users via a communications network and for quantifying interactions between the users and the digital content is also disclosed. The subject method includes the step of providing a first computer program for installation on one or more computers accessible to the plurality of users. Using the first computer program and the one or more computers, a list of digital content available from a source of digital content connected to the communications network is displayed. The method further includes the step of displaying selected digital content to a user in response to a selection by the user from the list, confirming access to the digital content by the user, and quantifying a plurality of interactions between the user and the digital content. Data representative of the plurality of interactions is stored in an interaction log. The data are periodically uploaded via the communications network to a database.

In certain embodiments, the method may further include the steps of providing a second computer program for installation on a computer accessible to an entity associated with the digital content and authorized to access data in the database. Using the second computer and the computer accessible to the entity, data representative of the plurality of interactions are displayed to the entity associated with the digital content. The second computer program and the computer are further used to perform the step of assessing a charge to be paid by the entity. The charge varies in response to the data representative of the plurality of interactions between the user and the digital content.

Certain embodiments include the additional step of defining a hierarchy of levels of interactions between the user and the digital content reflecting increases in engagement of the user with the content. Such embodiments further include the steps of monitoring, using the first computer program and the one or more computers, actions of the user and determining by said actions a level of interaction reached in the hierarchy of levels. A charge is then assessed to the entity based on the level of interactions reached by the user.

Additional features and advantages of the method and system will become apparent to those skilled in the art upon consideration of the following detailed description of the illustrated embodiment exemplifying the best mode of carrying out the method and system as presently perceived.

### BRIEF DESCRIPTION OF DRAWINGS

The present disclosure will be described hereafter with reference to the attached drawings which are given as non-limiting examples only, in which:

FIG. 1 is block diagram of an example machine that could be used to operate the visualization tool according to an embodiment of the present invention;

FIG. 2 shows a schematic representation of an illustrative embodiment of a system constructed in accordance with the present invention.

FIG. 3A is a block diagram which illustrates a set of interactions between an end user and the digital content.

FIG. 3B is a flow chart which illustrates the process of monitoring and quantifying an illustrative one of the interactions of FIG. 3A.

FIG. 4A is a flow chart which illustrates the process of creating an account for an entity authorized to view data generated by the system and method.

FIG. 4B is a flow chart which illustrates the process of initial enrollment and/or revisit of a “Tagged Visitor” (i.e., end user) of the system and method.

FIG. 4C is a flow chart which further illustrates processing of a new user of the subject system and method.

FIG. 4D is a flow chart which illustrates the process of new user account activation.

FIG. 4E is a flow chart which illustrates the process of setting up a customer account for a retailer.

FIG. 4F is a flow chart which illustrates the process of creating a new campaign and/or microsite using the system and method.

FIG. 4G shows an illustrative example of the file structure for a campaign root folder.

FIG. 5A shows an expanded representation of a portion of the subject system.

FIG. 5B shows an illustrative example of a report generated by the system and method.

FIG. 5C shows a portion of a spreadsheet which illustrates the workings of the system and method by way of an illustrative numerical example.

FIG. 6 illustrates a portion of a “dashboard” view generated by the system and method.

FIG. 7 shows an expanded representation of a portion of the subject system.

Corresponding reference characters indicate corresponding parts throughout the several views. The exemplification set out herein illustrates embodiments of the system and method, and such exemplification is not to be construed as limiting the scope of the claims to the particular examples described.

### DETAILED DESCRIPTION OF THE DRAWINGS

It is to be understood by one of ordinary skill in the art that the present discussion is a description of exemplary embodiments only, and is not intended as limiting the broader aspects of the present invention, which broader aspects are embodied in the exemplary embodiments.

This disclosure relates generally to a computer system and method for quantifying interactions with digital content accessible to a user via a network. In one embodiment, a computer program 204 is stored in the memory of a computer 202 accessible to the user. Program 204 is configured to allow the user to access digital content from a digital content source 208 via, for example, the Internet™. Computer program 204 includes one or more modules which cause the computer to confirm access of the digital content by the user, to detect, measure and quantify a plurality of digital interactions between the user and the digital content, and to store data representative of such interactions. A sending module in program 204 periodically uploads the data to a database 218 which is accessible to an entity sponsoring or associated with the digital content via a computer and a second program 222.

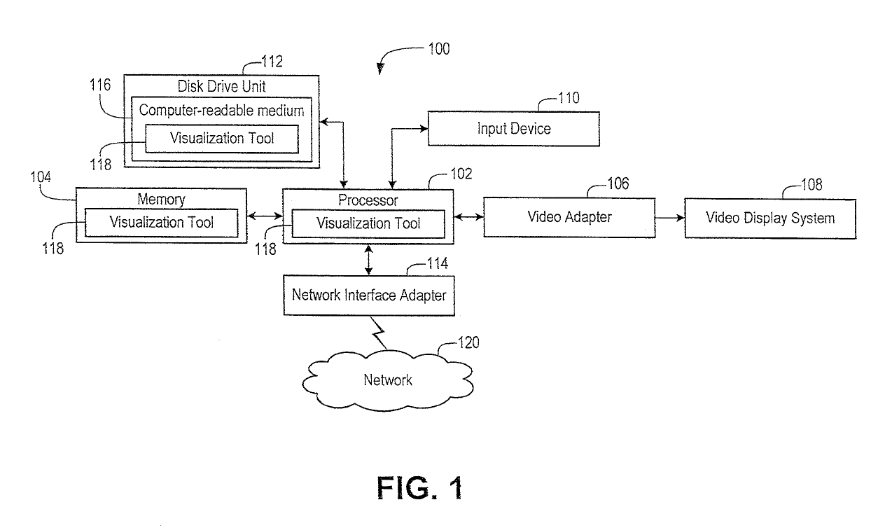

FIG. 1 illustrates a diagrammatic representation of a machine 100 in the example form of a computer system that may be programmed with a set of instructions to perform any one or more of the operations or methods discussed herein. The machine may be a personal computer, a tablet computer, a Personal Digital Assistant (“PDA”), a media player, a cellular telephone, a digital interactive television, or any machine capable of executing a set of instructions (sequential or otherwise) that specify actions to be taken by that machine. Unless otherwise indicated, use of the term “computer” in this specification is intended to be synonymous with “machine,” as described and defined herein.

The machine 100 may operate as a stand-alone device or may be connected (e.g., networked) to other machines. In embodiments where the machine is a stand-alone device, the set of instructions could be a computer program stored locally on the device that, when executed, causes the device to perform one or more of the methods or operations discussed herein. In embodiments where the computer program is locally stored, data may be retrieved from local storage or from a remote location via a network. In one embodiment, the computer program and data may be bundled together in a single file. For example, the program may be a Java applet and the data along with any components could be bundled together as a Java Archive (“JAR”) file. In this example, the JAR file could be communicated, such as via email, and executed by numerous types of machines that may have divergent hardware and run a variety of operating systems, including Windows, Linux, Mac OS, etc. In a networked deployment, machine 100 may operate in the capacity of a server or a client machine in a server-client network environment, or as a peer machine in a peer-to-peer (or distributed) network environment. Although only a single machine may be illustrated in some of the figures, the term “machine” shall also be taken to include any collection of machines that individually or jointly execute a set (or multiple sets) of instructions to perform any one or more of the methods discussed herein.

The example machine 100 illustrated in FIG. 1 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the machine 100 will not always include all of these peripheral devices.

The disk drive unit 112 includes a computer-readable medium 116 on which is stored one or more sets of computer instructions and data structures embodying or utilized by a search term visualization tool 118 described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the search term visualization tool 118 may be transmitted or received over a network 120 via the network interface device 114 utilizing any one of a number of transfer protocols including but not limited to the hypertext transfer protocol (“HTTP”) and file transfer protocol (“FTP”). The network 120 may be any type of communication scheme including but not limited to fiber optic, wired, and/or wireless communication capability in any of a plurality of protocols, such as TCP/IP, Ethernet, WAP, IEEE 802.11, or any other protocol.

While the computer-readable medium 116 is shown in the example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

In the discussion which follows, the term “module” is used in conjunction with the description of computer programs 204/206 and 222. For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

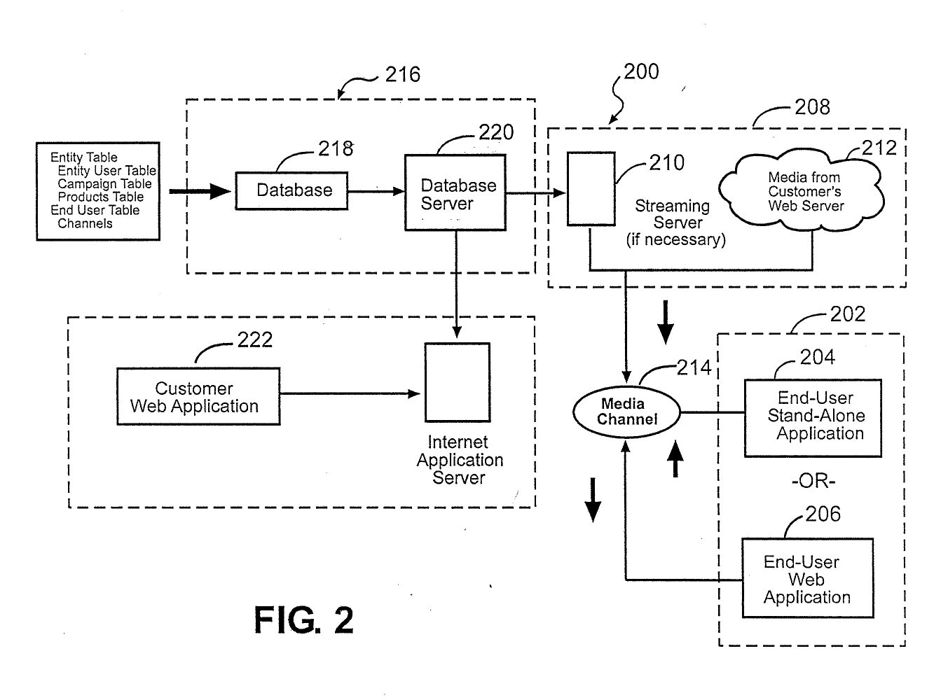

FIG. 2 shows a schematic representation of an illustrative embodiment of a system 200 constructed in accordance with the present invention. System 200 comprises a first computer 202 which may be a personal computer owned by an individual end-user, or a computer accessible to an end user. In one embodiment, computer 202 may have installed thereon a program 204 that enables the user to access certain digital content, as will be described more fully below. In addition, program 204 stores certain identifying information associated with the user, tracks and stores information regarding the user's exposure, engagement and interactions with digital content, and uploads data representative of this information to a database. In an alternative, but equivalent, embodiment, a program 206 having some or all of the functionality of program 204 may be stored in the memory of a computer which is accessible to the user via a network, such as the Internet™ For example, information identifying the end user could be stored on computer 202, and a web browser could be used to access program 206 to perform the operations and methods discussed herein.

System 200 further includes a source of digital content 208. Digital content source 208 can include a dedicated server 210 capable of streaming digital content in the form of text, video, audio, still-picture or other form. Alternatively, or in addition to server 210, such content may be made available through the web server 212 of an entity, such as a retailer or other provider of goods/services, an advertising agency, or other authorizing party.

Digital content from servers 210 and/or 212 is made available via a network accessible by computer program 204 and/or 206. In one embodiment, digital content may be made available to the end user via a media channel 214 that may be dedicated to a single vendor, or multiple vendors offering similar goods/services (jewelry, sporting goods, clothing, etc.), or multiple vendors offering multiple products/services (e.g., an online shopping mall).

System 200 further includes a data storage capability 216 which, in one embodiment, comprises database 218 and database server 220. Database 218 receives data uploaded from computer program 204 and/or 206, as will be discussed in more detail below. Database 218 is organized to include a plurality of tables to accommodate data received from a respective plurality of end users.

System 200 further includes computer program 222 which, in one embodiment, is a web-based application accessible by entities associated with the digital content made available through digital source 208. For purposes of this description, the term “entity” may include a retailer, a manufacturer or provider of products/services, a distributor, a wholesaler or similar organization, or an organization affiliated with or authorized to act on behalf thereof, such as an advertising agency.

Computer program 222 becomes accessible to an entity through an account creation process described more fully below. Once accessible to an entity, program 222 provides an authorized entity access to data within database 218 that is specific to that entity. To that end, database 218 may include entity/user tables, advertising campaign tables, products/services tables, etc., as required or appropriate to provide the desired level of access to the entity.

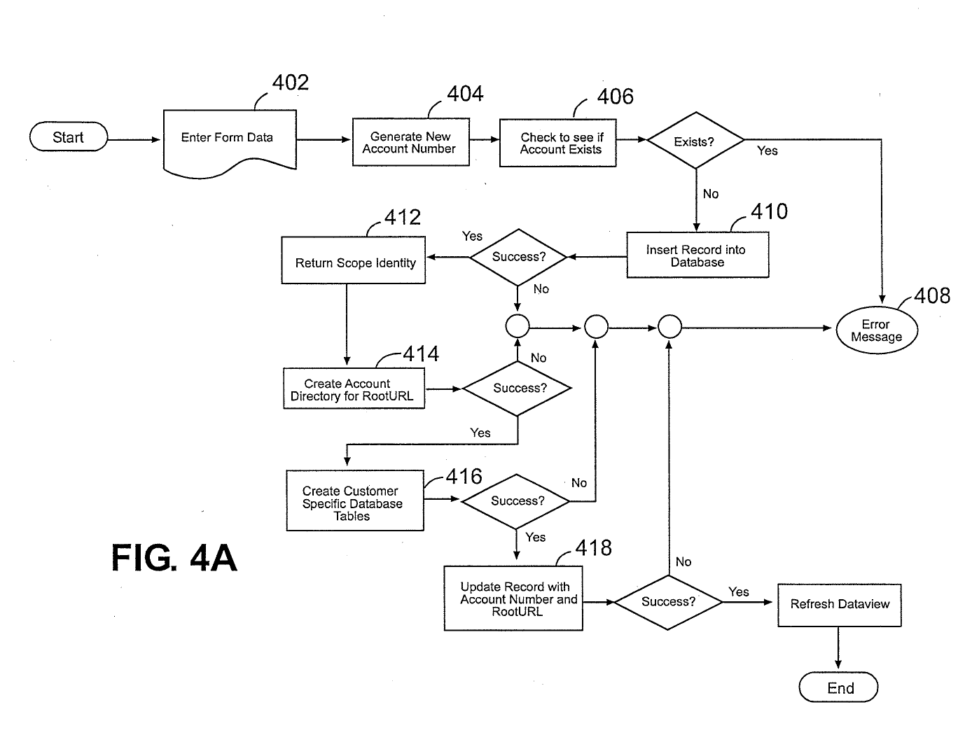

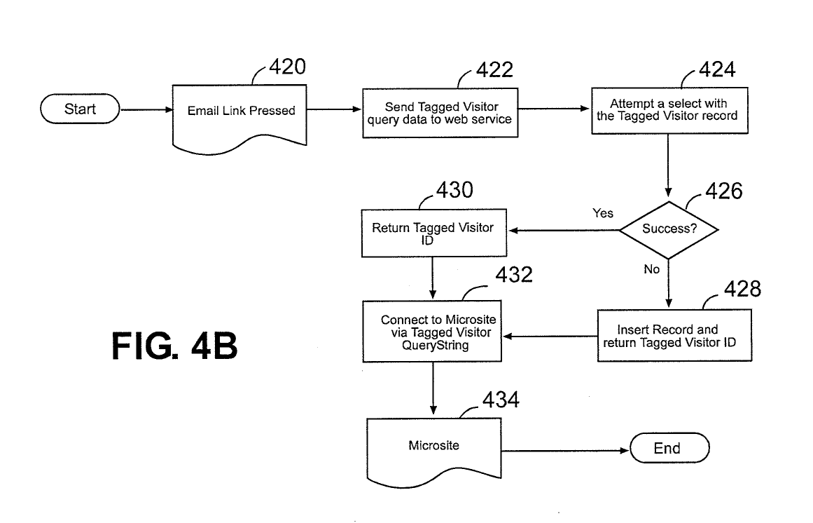

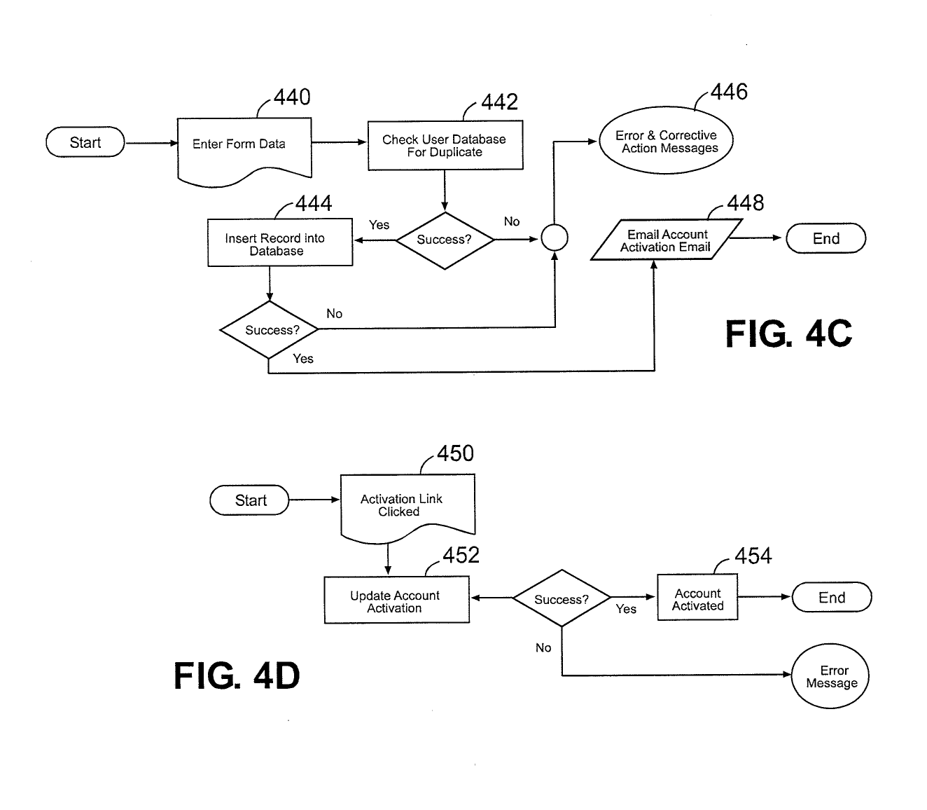

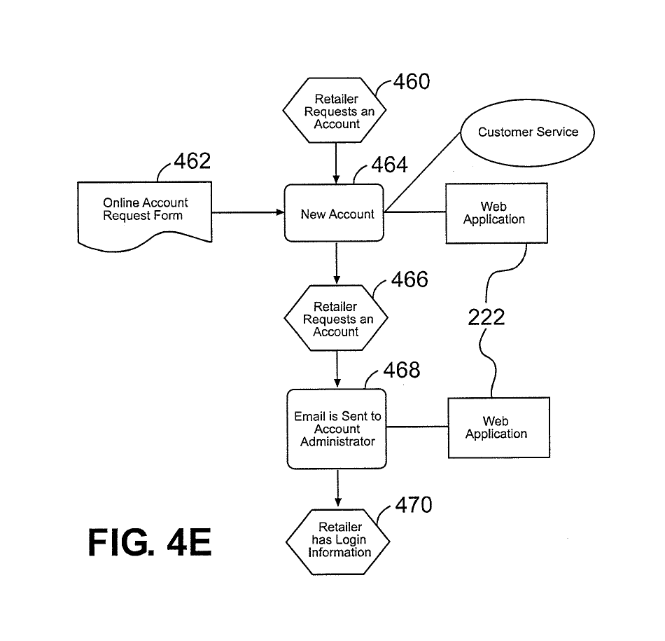

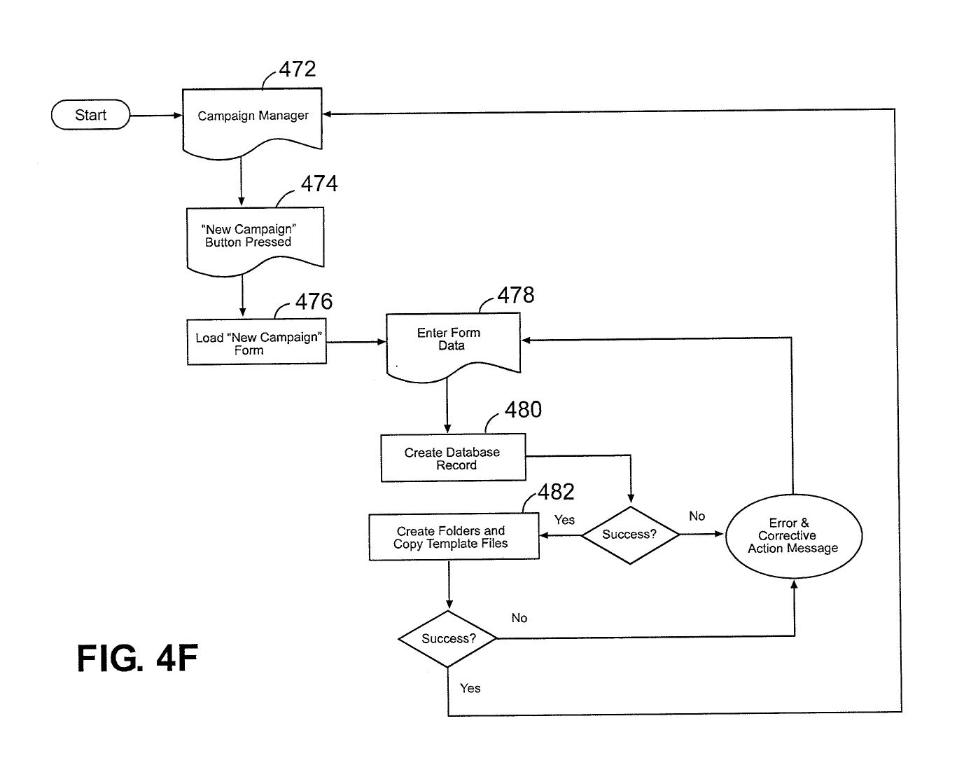

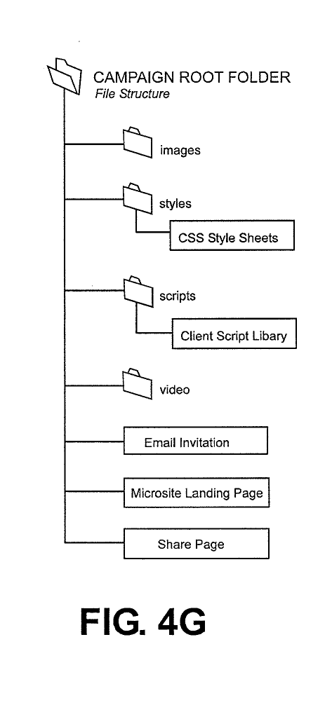

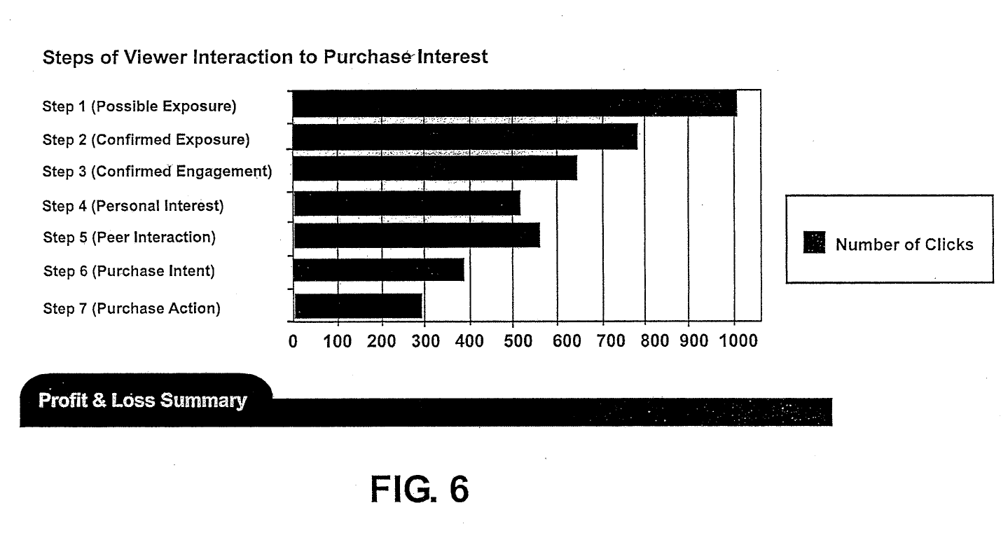

In a preferred embodiment, program 222 includes an account module for creating an account record (see FIG. 4) which contains identifying information relating to a particular entity, and which generates information and data (e.g., account numbers, directories and database tables) for a particular entity. Program 222 further includes a display module for creating entity-specific displays (see FIG. 6) from data relating to digital content associated with the entity. Computer program 222 may also include a charge module for determining an advertising charge or fee which is based upon interactions between an end user and the digital content. In a preferred embodiment, the amount or level of the charge determined by the charging module increases with increasing levels of interactions between the user and the digital content.

Program 204/206 (referred to hereafter as program 204) allows the end user to access the digital content made available from digital source 208. Program 204 includes a module which causes computer 202 to confirm access of digital content (e.g., a particular advertisement or video relating to a particular product/service) by the user. This program module is further configured to quantify a plurality of interactions which may occur between the user and the digital content. The module further stores data representative of the interactions. Program 204 further includes a sending module for causing computer 202 to transmit or upload the stored data to database 218. In database 218, the data relating to the interactions between the user and the digital content are used to populate and/or update appropriate tables relating to the user and, for example, a particular product/service associated with the digital content, a particular advertising campaign, a particular entity associated with the content, etc. In certain embodiments, a charge module of the type referred to above in connection with program 222 may also be included in program 204.

In operation, an entity creates an account using the account module in program 222 and recruits a group of users to receive digital content in the form of, for example, advertisements and scheduled campaigns. The users are provided (or have access to) program 204. When program 204 runs, the users see a list of items that appear on their computer display through the action of program 204. Viewing of the items may be incentivized by promotions or other means to entice the viewer to access a particular item of digital content.

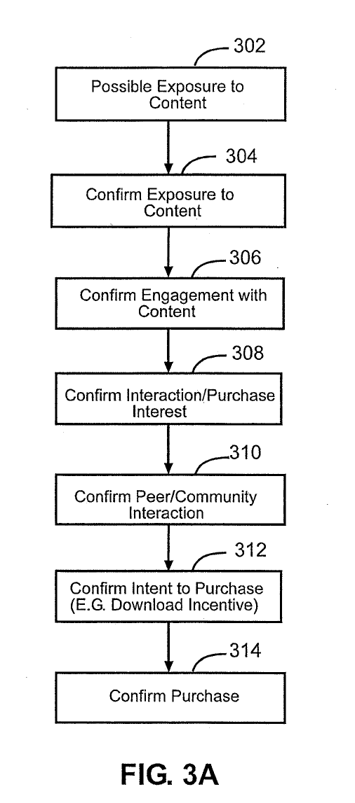

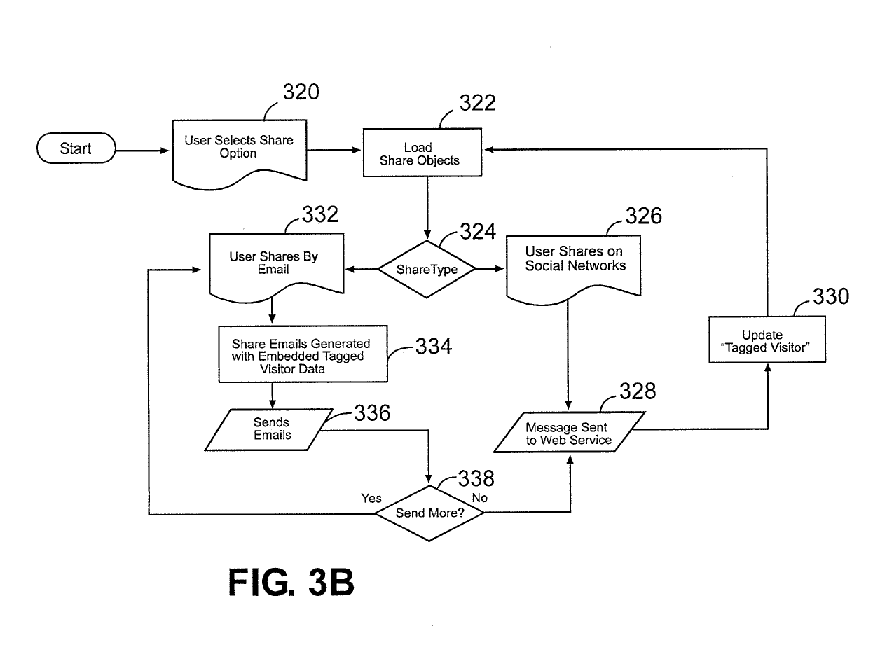

When the user “clicks” or otherwise accesses the digital content, media is made available to the end user through media channel 214. Program 204 measures viewing statistics and interactions (see FIG. 3A) as the digital content is viewed. Data reflecting these measurements and interactions are subsequently uploaded to database 218 and used to update the appropriate user and entity tables. The sponsoring entity can access the data via program 222 at any time to view the uploaded data and evaluate the effectiveness of the digital content.

The sponsoring entity is exposing a user to digital content (e.g., a video) with the intent of modifying the future behavior of the user. Specifically, the sponsoring entity is desirous of moving a user along a behavioral continuum toward a desired future state/action which, in many cases, is a purchase transaction. The present system and method is designed to measure and quantify specific behavioral-modification steps along this continuum. The ability to so measure and quantify the steps will allow the sponsoring entity to evaluate the effectiveness of the digital content, compare the effectiveness of campaigns or promotions using different digital content, determine a return-on-investment in various campaigns and content, and/or realize other advantages.

FIG. 3A is a block diagram which illustrates one possible set of interactions between an end user and the digital content. With reference to block 302 of FIG. 3A, the first level of “interaction” is possible exposure of the end user to the content. When an end user starts or logs onto program 204, a list of specific digital content in the form of, for example, videos, may be made available for viewing. The end user may or may not choose to view a video, but the possibility of exposure has been realized. In one embodiment, no specific charge would be assessed at this level of interaction. However, the sponsoring entity may be charged a set fee for utilizing the system, even if a user does not opt for viewing a video.

If the end user chooses to view a video, a module in program 204 confirms access of this content by the user. This level of interaction is represented in FIG. 3A by block 304. The program module confirms, for example, whether the user receives the video and “clicks” play to begin watching the video. A charge may be assessed to the advertiser or sponsoring entity based upon this confirmed exposure.

The program module which confirms access of the video is further configured to determine whether the user views all, or only some portion of, the video. This level of interaction confirms that the viewer is engaged with the content and is represented by block 306 of FIG. 3A. In one embodiment, if the user views an entire video, an additional charge is assessed by the charge module. As noted, the charge module may be part of program 204 and, thus, include data representative of the charge as part of the data uploaded to database 218. Alternatively, the charge module may be part of program 222, in which case the charge is assessed based upon the data uploaded to database 218 by program 204.

In addition to viewing the video to completion, the end user may engage the content by a “click” or other action to cause additional, related digital content to be made available. This action is represented by block 308 of FIG. 3A, and further confirms the user's actual engagement with the content. Examples of an interaction at this level may be an action to request more information regarding the product/service. Such information may take the form of features, benefits, specifications, or other information relating to the subject product/service. Since the action of requesting such information clearly indicates a higher level of interaction with the digital content, the charge module of program 222 (or 204) will assess an additional charge.

Block 310 represents yet another level of interaction in which the user shares information relating to the content with a friend, peer, social network, or other online community. Again, the charge module may assess an additional cost if the data uploaded by program 204 indicates that such sharing of information relating to the content has occurred.

Block 312 of FIG. 3A represents yet another heightened level of interaction with the digital content. In this case, the user of program 204 is given an option to download and/or print an incentive relating to the product/service. Such an incentive may take the form of a coupon, which may be printed and used in a traditional manner, or a promotional code which may be stored and used for online shopping. Both coupon and promotional code include identifying information indicative of the source of the incentive. For example, a bar code may be printed on a coupon and scanned at a point of purchase. The downloading of an incentive may be taken as an expression of an immediate intent to purchase the subject product/service. Accordingly, the charge module may assess an additional charge based upon this level of interaction.

Finally, if the user redeems the incentive in a purchase transaction, the identifying information associated with the incentive can be stored and subsequently identified to the user. An actual purchase that can be linked to the data uploaded by program 204 is a direct indication to the sponsoring entity that the digital content was instrumental in facilitating a sale. That is, if the user presents a bar coded coupon that is directly tied to a video presentation viewed using program 204, the entity sponsoring the video can be assured of a real return on investment in the video. This level of interaction (or action) on behalf of the user is represented in FIG. 3A by block 314. An additional charge may be assessed by the charge module whenever a specific purchase is tied to the viewing and interactions with specific digital content.

FIG. 3B is a flow chart which illustrates the process of monitoring and quantifying an illustrative one of the interactions of FIG. 3A. Specifically, FIG. 3B illustrates the manner in which the subject system and method confirms and documents an interaction described in connection with block 310 of FIG. 3A. With reference to FIG. 3B, a user viewing digital content may share selected content with a friend, peer, social network or other online community (block 320). In that event, object or objects to be shared are loaded by the system (block 322). The system makes a record of the share type (block 324). For example, if a user shares the subject content on a social network (e.g., Facebook™ ), that information is posted (block 326) and an email message is sent to a web service (block 328) and the record for the user is updated (block 330). If the user shares the subject content with another user or peer by email (block 332), emails are generated by the system with embedded user data (block 334). The emails are sent (block 336) and the user is given an option to send additional emails to others (block 338). If no additional emails are to be sent, a message is sent to a web service (block 328) and the record for the user is updated (block 330) by the system to appropriately reflect this level of interaction.

FIG. 4A is a flow chart which illustrates the process of creating an account for an entity which will provide or be associated with digital content made available by digital source 208 for viewing and interaction by an end user via program 204, and which will be granted access to database 218 to review data uploaded by program 204 relating to the digital content. The operations represented in FIG. 4A include entering data regarding the entity (block 402) and generating a new account number (block 404) The system checks to see if an account already exists for the entity (block 406). If so, an error message is generated (block 408) If not, a record is inserted into database 218 (block 410). If this operation is successful, an identity and account directory are created for the entity (blocks 412-414). If these operations are successful, entity (or “customer”) specific database tables are created in database 218 (block 416). Such tables will be populated by the data uploaded from various end users. This typically takes place in a batch process that is run periodically (e.g., daily). Finally, the record in database 218 is updated accordingly (block 418). Accurate account creation is important to the overall process. After an account is created, the entity associated with the account will typically have the ability to recruit and set up end users, run advertising campaigns, upload videos and/or other digital content, create microsites, and view the data in database 218 to measure the effectiveness of all of the above.

FIG. 4B is a flow chart which illustrates the process of initial enrollment and/or revisit of a “Tagged Visitor.” For purposes of this specification, a Tagged Visitor is an end user for whom a record has been created and an ID has been assigned in the system. This allows the system to identify the viewer by individual email address, and further allows the system to determine the level of interaction reached between the user and the digital content. With reference to FIG. 4B, the process begins when a user presses or selects a link provided in an email directed to the user's address. This action is represented in FIG. 4B by block 420. The link connects the user to a web service (block 422) which attempts to match the user's email address with an existing Tagged Visitor record (block 424). If this attempt is not successful (decision operation 426), a record is inserted into the system and an ID is created for the subject user. (block 428). If the attempt at block 424 is successful, the user ID is returned (block 430) and the user is connected to the appropriate digital content (block 432). The content may be embedded in a website or microsite. For purposes of this specification, a “microsite” is a separate page of the website that has a separate URL and is used to provide information about and/or to promote a particular product or service, or information that is related to the sponsoring entities' promotions or advertising campaigns. For example, a retailer may send emails to past customers as part of a promotional campaign. The emails may contain a link to a microsite with information or special offers. The microsite may contain a video, or other digital content, with which the Tagged Visitor can interact, and such interactions can be monitored and quantified as described above. In the illustrated embodiment, the Tagged Visitor is connected to the microsite (block 434) via a “Tagged Visitor Query String.” The query string is an encrypted string of name/value pairs that describe the Tagged Visitor record. It is used to prevent duplication of records and in maintaining data integrity.

FIG. 4C is a flow chart which further illustrates the process of registering a new end user. The process of FIG. 4C may be used as an alternative to the process of FIG. 4B in the event, for instance, that a group of new users are being recruited by a particular entity as part of a new campaign or promotion. With reference to FIG. 4C, a new user enters data into a form (block 440), and a user database is queried to check for duplication (block 442). If there is no duplication, a record is created and inserted into the user database (block 444). If, for whatever reason, a new record cannot be created, appropriate error and corrective action messages are generated (block 446). Upon successful creation of a record, an account activation email is forwarded to the new user (block 448).

FIG. 4D is a flow chart which illustrates the process of new account activation. Upon receipt of the account activation email, an activation link is clicked (block 450). This sets in motion the process of updating the account activation (block 452). If successful, the account is activated (block 454) and ready for use.

FIG. 4E is a flow chart which illustrates the process of setting up a customer account for a retailer. When a retailer requests an account (block 460), an electronic request form is made available (block 462). When the account form is completed and submitted, a customer service representative sets up a new account (blocks 464 and 466). An email notification is sent to the account administrator (block 468) indicating that the account is ready for use. Access to computer program 222 is then provided. The retailer may then assign logins to its staff, create and deploy campaigns on the system and view metrics and other data (block 470), via computer program 222.

FIG. 4F is a flow chart which illustrates the process of creating a new campaign and/or microsite using the subject system and method. With reference to FIG. 4F, an entity such as a retailer or other advertiser accesses a “Campaign Manager” (block 472), via program 222, and selects “new campaign” (block 474). A new campaign form is made available to the entity (block 476). Data is entered in a campaign data form (block 478). Forms may also be provided for entering information regarding an email template and, if a microsite is being set up, a microsite template. A database record is created for the campaign or microsite (block 480). If successful, folders are created and template files are copied (block 482). FIG. 4G shows an example of the file structure of a campaign root folder which is created in the system.

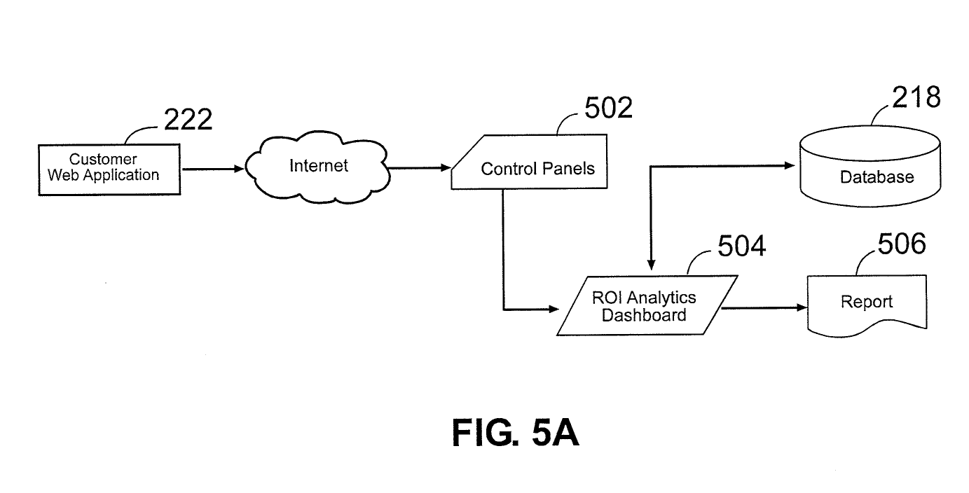

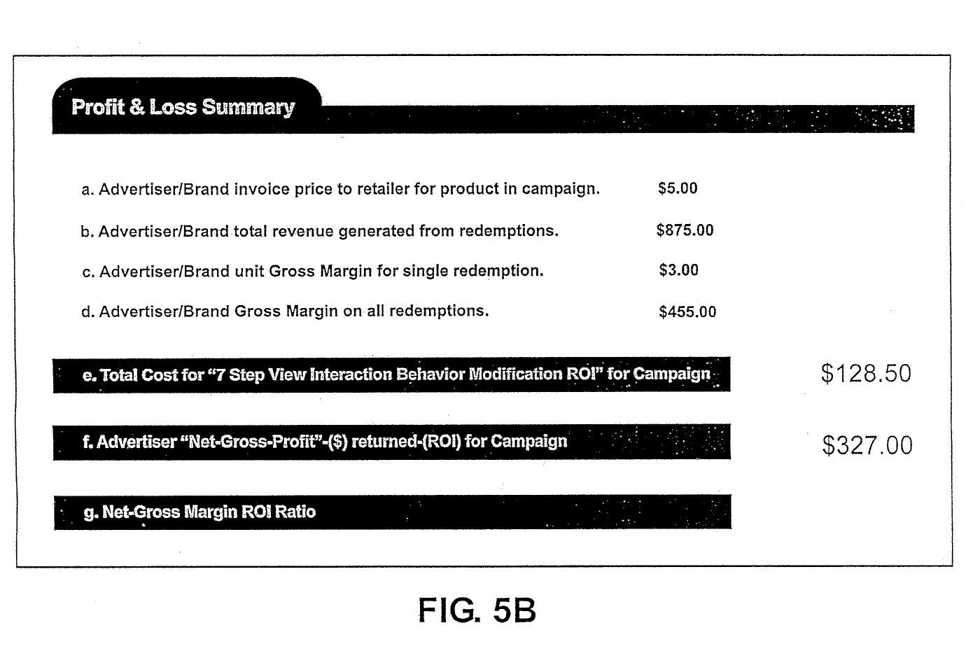

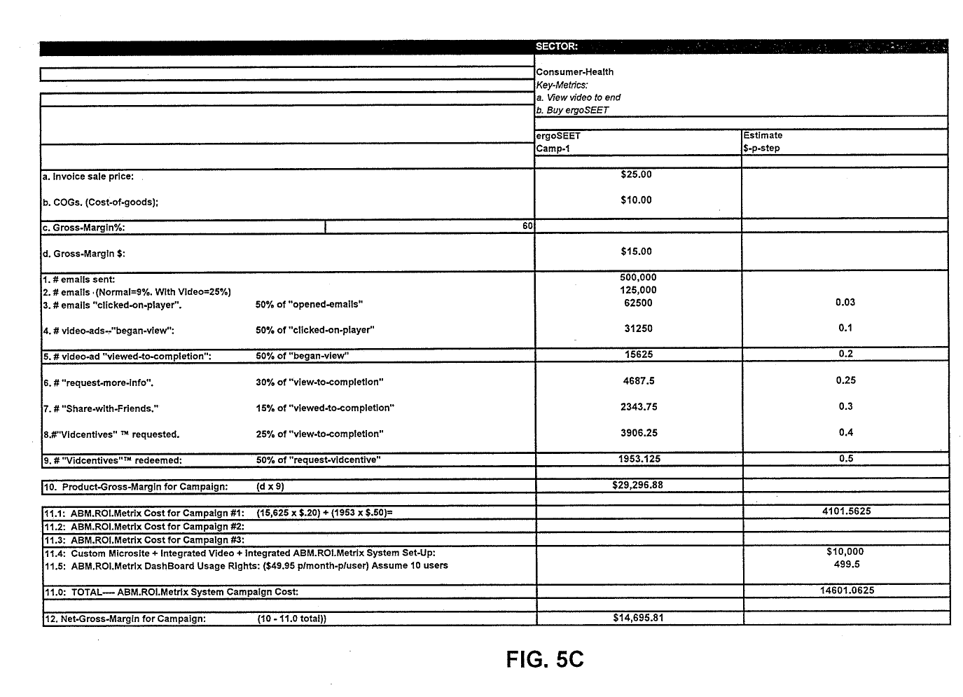

FIG. 5A shows an expanded representation of the workings of computer program 222 as used by a sponsoring entity to view the data in database 218. As illustrated, an entity having properly created an account, recruited users, and launched an advertising campaign by uploading or otherwise providing digital content to the users from digital content source 208 can log in to a website to view data uploaded by the users. Upon logging in, the entity will be presented with one or more control panels 502 to allow the entity to navigate to the data which may be presented in tabular, graphical or other form. The data and “return investment” analytics may also be presented in the form of a dashboard (see FIG. 6), as indicated in FIG. 5A by block 504. The analytics module of block 504 renders a report 506 from data in database 218.

FIG. 5B shows an illustrative example of a profit and loss summary report 506 generated by the analytics module of block 504.

FIG. 5C shows a portion of a spreadsheet which illustrates the workings of the system and method by way of an illustrative numerical example. In the example of FIG. 5C, a product in a sector labeled “Consumer-Health” is the subject of an advertising campaign using the disclosed system and method. The invoice sale price of the product is $25.00. The cost of goods sold is $10.00, leaving a gross margin of $15.00. For the sake of this example, it is assumed that 500,000 emails are sent to end users promoting the subject product. It is further assumed that 125,000 of these emails are opened by the end users. In this example, no charges are assessed for these actions.

Continuing the numerical example, it is assumed that, of the 125,000 emails which are opened, half (62,500) of the users click on a video player to indicate some intention to view a video embedded in the email. A charge of 3 cents per “click” is assessed for this level of interaction. Next it is assumed that half (31,250) of the users who opened the video player actually begin viewing the subject video. A charge of 10 cents per user is assessed for all those who begin viewing the video. It is next assumed that half (15,625) of those who begin viewing the video actually view the video to completion. A charge of 20 cents per user is assessed for those viewing the video to completion.

Next, it is assumed that 30% (4,687) of those who view the video to completion request more information regarding the subject product. A charge of 25 cents per user is assessed for these interactions. It is further assumed that 15% (2,343) of those who viewing the video to completion share the video with a friend, peer or other. A charge of 30 cents is assessed for each of the users who choose to share the information. Continuing on, it is further assumed that 25% (3,906) of those viewing the video to completion request an incentive (e.g., a coupon) relating to the product. A charge of 40 cents per request is assessed for this level of interaction. Finally, it is assumed that half (1,953) of those requesting incentives actually redeem the incentive in a purchase transaction, and that data relating to these transactions are entered into the system. A charge of 50 cents per transaction is assessed for this level of interaction.

As indicated in FIG. 5C, the total gross margin for all products sold (i.e., $15.00 times 1,953) is $29,296.88. In this illustrative example, although charges have been assessed for seven levels of interaction, only levels 5 and 9 are actually being charged to the advertising entity. Thus, the total amount being charged for the interactions is $4,101.56. In a different example, the total charge might include charges for all of the 7 levels of interaction illustrated or for some different combination of fewer than all of the levels illustrated. It is emphasized that the particular example shown in FIG. 5C is illustrative only.

With reference to line 11.4 of the spreadsheet of FIG. 5C, an amount is entered for costs incurred by the entity in producing the video, setting up the microsite, and other expenses. For purposes of this example, this cost is assumed to be $10,000.00. Finally, a charge by the owners of the system and method to compensate for access by the advertiser to the system (particularly the ROI Analytics) is assumed to be $499.50. Thus, the total cost to the sponsoring entity is $14,601. This leaves a net margin of $14,695.81 based on sales of 1,953 units for the campaign.

The disclosed system and method make it possible to compare the effectiveness of alternative campaigns. For example, if an alternative campaign for the same product illustrated in the spreadsheet of FIG. 5C utilizes a less expensive video, but results in a comparable number of “views to completion” and actual sales, then the net margin will be greater indicating a higher return on investment. In this manner, an entity could try out several campaigns to evaluate the relative effectiveness of each. Then, the campaign that indicates the highest level of effectiveness could be used with wider distribution to maximize the return on the marketing dollars expended.

It should be noted that, although the illustrative example discussed above is described in the context of an interactive, network-based system of computers, application of the subject system is not so limited. Specifically, the disclosed system and method can be used with any interactive system capable of distributing digital content for purposes of marketing and advertising. An example of such system which may widely exist in the future is digital interactive television. In such a system, a viewer may be able to interact with digital content distributed via cable, satellite or broadcast TV. Such systems will, in essence, be “computer systems” as that term is used in this specification, and are specifically intended to be covered by the claims.

FIG. 6 illustrates a portion of a “dashboard” view generated by analytics dashboard 504. This dashboard view allows the advertising entity to quickly assess the effectiveness of a particular video, and to more quickly compare one video or other type of digital content to another.

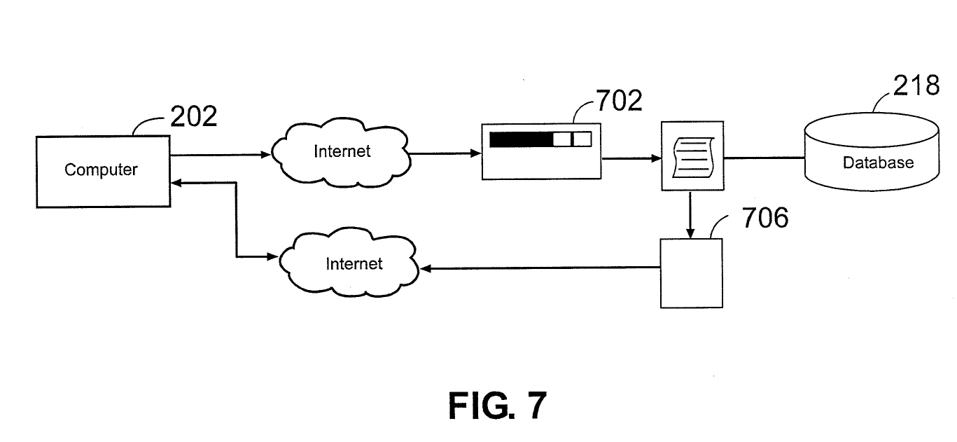

FIG. 7 shows an expanded partial illustration of the operation of end user computer program 204. Specifically, FIG. 7 illustrates in expanded form a portion of the interaction between end user computer 202 and database 218. When a user turns on computer 202, computer program 204 runs. When an Internet™ connection is established, the application queries a web service 702 based on permission-based settings provided by the user. The web service transmits the request to a script that queries database 218 for a list of applicable digital content or incentives. Incentives may be employed as a means for enticing the end user to view the digital content. The incentives 706 are rendered into an XML data file and transmitted to computer 202. Computer program 204 on computer 202 caches the XML file and uses it to render the incentives for display to the user. Printable coupons, promotional codes and various incentives may be similarly provided to the user.

In a preferred embodiment, computer program 204 is an installed Flash™ application that is downloaded by the user and installed on computer 202. Flash™ is a multimedia architecture developed by and available from Adobe Systems. Flash™ has a high adoption rate and is the de facto standard for rich media delivery. Computer program 204 allows the user to browse particular brands or product types, or groups of local and/or national retailers in order to get the latest information on sales, special offers, coupons and advertisements. The actions of computer program 204 in confirming and quantifying the interactions of the user, combined with the capabilities provided by computer program 222 to an entity associated with the content made available to the user, benefits both the user and the sponsoring entity in ways that have previously been unavailable to either.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A system for quantifying interactions of a user with digital content stored on a digital content source accessible to a user via a network, comprising:
a first computer program, stored in a memory of a computer accessible to the user, said first computer program configured to allow the user to access the digital content stored on the digital content source;
a program module in said first computer program causing the computer to confirm access of the digital content by the user, and to quantify a plurality of interactions between the user and the digital content, and to store data representative of the quantifications; and;
a sending module causing the computer to transmit the data to a database.

2. The system of claim 1, further comprising a second computer program, stored in the memory of a computer accessible to an entity authorized to access the data in the database, said second computer program comprising an account module for creating an account record containing identifying information specific to the entity, and a display module for creating entity-specific displays from the data.

3. The system of claim 2, wherein one or both of said first and second computer programs further comprises a charge module configured to determine and store a charge based upon the data representative of the quantifications.

4. The system of claim 3, wherein a level of the charge determined by the charging module increases with increasing levels of interactions between the user and the digital content, as measured by the data representative of the quantifications.

5. The system of claim 3, wherein said program module is configured to determine whether the user accessed all, or only a part of, a designated portion of the digital content.

6. The system of claim 5, wherein said charging module is configured to determine a charge based upon whether the user accessed all, or only a part of, the designated portion of the digital content.

7. The system of claim 5, wherein said program module is configured to determine whether the user interacted with the digital content to cause additional, related digital content to be made available to the user.

8. The system of claim 7, wherein said charging module is configured to determine a charge if the user interacted with the digital content to cause additional, related digital content to be made available to the user.

9. The system of claim 7, wherein said computer program module is configured to determine whether the user forwarded information relating to the digital content to another user.

10. The system of claim 9, wherein said charging module is configured to determine a charge if the user forwarded information relating to the content to another user.

11. The system of claim 9, wherein said computer program module is configured to determine whether the user downloaded information relating to the content for storage on the computer.

12. The system of claim 11, wherein said charging module is configured to determine a charge if the user downloaded information relating to the content for storage on the first computer.

13. The system of claim 11, wherein said computer program module is configured to determine whether the user downloaded incentive data relating to the content for storage on the first computer.

14. The system of claim 11, wherein said charging module is configured to determine a charge if the user downloaded incentive data relating to the content for storage on the first computer.

15. The system of claim 13, wherein said incentive data comprises a printable file including an indicia indicative of the source of the incentive data.

16. The system of claim 13, wherein said incentive data comprises a promotional code relating to a product or service associated with the digital content.
